(19) United States
(12) Patent Application Publication
(10) Pub. No.: US 2026/0049658 A1
(43) Pub. Date: Feb. 19, 2026

(54) METHOD FOR OPERATING A DRIVING DEVICE OF A WORKING MACHINE

(71) Applicant: ZF Friedrichshafen AG, Friedrichshafen (DE)

(72) Inventors: Simon Geiger, Oberteuringen (DE); Matthias Duller, Friedrichshafen (DE)

(73) Assignee: ZF Friedrichshafen AG, Friedrichshafen (DE)

(21) Appl. No.: 19/250,331

(22) Filed: Jun. 26, 2025

(30) Foreign Application Priority Data
Jun. 28, 2024 (DE) 10 2024 206 075.5

(51) Int. Cl. F16H 61/472; F16H 59/68; F16H 61/4017; F16H 61/478

(52) U.S. Cl. CPC F16H 61/472; F16H 59/68; F16H 61/4017; F16H 61/478; F16H 2059/6861

(57) ABSTRACT

A method is provided for operating a drive device for a working machine having a conventional maximum traction force curve, where the maximum permissible traction force of the drive device increases as the output speed of the drive device decreases. The method includes receiving an activation signal for activating a grading operation of the working machine, where the grading operation has a limited maximum traction force curve in which the maximum permissible traction force of the drive device increases less sharply than with the conventional maximum traction force curve as the output speed of the drive device decreases. A currently maximum permissible traction force is ascertained based on the limited maximum traction force curve and a current traction force is compared with the currently maximum permissible traction force. The transmission ratio of the gearbox is adjusted toward a lower output speed of the drive device based on the comparison.

### RELATED APPLICATIONS

This application claims the benefit of and right of priority under 35 U.S.C. § 119 to German Patent Application no. 10 2024 206 075.5, filed on 28 Jun. 2024, the contents of which are incorporated herein by reference in its entirety.

### TECHNICAL FIELD

The present invention relates to a method for operating a drive device of a working machine. The working machine may be a grader. Furthermore, the present invention relates to a control device that is designed to carry out such a method, to a drive device with such a control device, and to a working machine with such a drive device.

### BACKGROUND

In the field of working machines, drive systems with an engine and a power-split gearbox are used. Such power-split gearboxes can feature a variator that allows the transmission ratio of the gearbox to be adjusted continuously. In levelers, which are also known as graders, conventional gearboxes with a fixed transmission ratio in the selected gear are used, in which the output speed and thus the driving speed are permanently linked to the engine speed. When the load acting on the grader increases, the driver receives feedback via the engine's pressure and a deceleration of the vehicle.

### SUMMARY

The present invention relates to a method for operating a drive device for a working machine. The working machine may be a construction, agricultural, or forestry machine. For example, the working machine can be a grader, also known as a leveler. The grader may have a grader blade that can be positioned between the front and rear axles of the grader. The grader blade can be rotated, tilted and, alternatively or additionally, adjusted by approx. 90° on both sides to enable work on inclined surfaces. The drive device has an engine and a power-split gearbox. The engine may be an internal combustion engine and, alternatively or additionally, an electric engine. The power-split gearbox can be a hydrostatic-mechanical transmission and, alternatively or additionally, an electric-mechanical power-split gearbox. The power-split gearbox can have a mechanical power branch and a hydrostatic and, alternatively or additionally, electric power branch. The power-split gearbox features a variator to enable stepless adjustment of the transmission ratio of the gearbox. For example, the power-split gearbox can be designed so that different fixed transmission ratios between a drive and an output of the gearbox can be switched via a mechanical power branch. The different transmission ratios may correspond to the operating ranges of the working machine. Within these driving ranges, the transmission ratio can be continuously adjusted using the variator. The variator can be designed as a hydrostat and have two hydraulic machines that can be connected to each other in a hydrodynamic manner. Alternatively, or additionally, the variator can also have two electric machines that can be electrically connected to each other.

The drive device has a conventional maximum traction force curve, in which the maximum permissible traction force of the drive device increases as the output speed of the drive device decreases. The output speed of the drive device can be related to the reciprocal transmission ratio of the power-split gearbox and, alternatively or additionally, to the travel speed of the working machine in a fixed manner. Accordingly, the conventional maximum permissible traction force curve can be designed such that the maximum permissible traction force increases as the driving speed decreases. The drive device can have different maximum permissible traction force curves for different speeds of the engine of the drive device, which may be identical in their curve, However, the different maximum permissible traction force curves can assign different maximum permissible traction forces to different output speeds of the drive device. The engine speed can range from 1000 to 2500 rpm, for example. The conventional maximum permissible traction force curves can be designed so that they decrease moderately, for example linearly, in the range of lower driving speeds with increasing driving speed, and then decrease more sharply, for example exponentially.

The method comprises receiving an activation signal for activating a grading operation of the working machine. The grading operation of the working machine can be activated by the working machine operator using a switch, or automatically, based on certain status variables. The grading operation of the working machine may involve grading a surface, in which case wheel spin must be prevented. The grading operation exhibits a limited maximum traction force curve, in which the maximum permissible traction force of the drive device increases less sharply than in the conventional maximum traction force curve as the output speed of the drive device decreases. In other words, the grading operation is designed in such a way that the traction force of the drive device is lower than in conventional operation when the working machine decelerates. This reduces the risk of the wheels of the working machine spinning during grading operations. The limited maximum traction force curve can result in lower traction forces than the conventional traction force curve, either in sections or across the entire range.

The limited maximum traction force curve can be linear, quadratic, exponential, or of another type, as long as it has lower values than the conventional traction force curve when the output speed of the drive device decreases. The limited maximum traction force curve may have a shape in which it increases overall as the output speed of the drive device decreases, but it may also allow a decrease in traction force in certain ranges. Activating the grading operation can be linked to various conditions, for example, that a driver of the working machine must explicitly switch on the grading operation. Alternatively, or additionally, it may be necessary for the maximum speed of the working machine set by the driver, for example by specifying a virtual gear, to be below a certain maximum speed, for example below a certain virtual gear. This ensures that the grader blade is only activated at travel speeds suitable for grading operation and when explicitly requested by the driver. In an alternative embodiment, only one of these conditions may be required to activate the grading operation. The drive device can have different limited maximum traction force curves for different speeds of the engine of the drive device, which can be designed as described above in connection with the conventional maximum traction force curve.

The method also includes ascertaining a currently maximum permissible traction force based on the limited maximum traction force curve, for example based on the limited maximum traction force curve corresponding to the current engine speed. For this purpose, the current travel speed, the current transmission ratio, for example the current reciprocal transmission ratio, and alternatively or additionally the current output speed at the output of the drive device can be detected. The maximum permissible traction force can now be ascertained from the limited maximum traction force curve for this measured variable. In addition, the current traction force of the drive device can be determined, which can be done, for example, based on a sensor device in the variator of the drive device. This sensor device can be used, for example, to determine a pressure variable in the variator that may be in a defined relationship with a traction force provided by the drive device. In one embodiment, the current traction force is determined based on a differential pressure in the variator.

The method also includes comparing the current traction force with the current maximum permissible traction force. If the current traction force exceeds the currently maximum permissible traction force, which was ascertained based on the limited maximum traction force curve, the method adjusts the transmission ratio of the gearbox to a lower output speed of the drive device. For example, the variator of the power-split gearbox can be adjusted to reduce the reciprocal transmission ratio of the gearbox, i.e., to increase the transmission ratio. By adjusting the transmission ratio to a lower output speed and thus a lower driving speed, the working machine is slowed down. If, for example, the working machine is in a grading operation and the load acting on the working machine increases, the traction force can rise to the current maximum permissible level. The gearbox is then adjusted so that the vehicle slows down accordingly until the load no longer exceeds the maximum permissible traction force at that moment. By limiting the traction force based on the limited maximum traction force curve, moderate increases in traction force can be provided at the output of the drive device even with a power-split gearbox with a variator when the output speed decreases. This effectively prevents the wheels of the working machine from spinning, resulting in improved machining results and more comfortable machine operation.

In one embodiment, the method comprises ascertaining a maximum speed of the working machine. For example, the maximum speed can be specified by the operator of the working machine by setting a working speed. In one embodiment, the maximum speed can be set by setting so-called virtual gears, which can correspond to specific maximum speeds. in addition, the method may include reading in a permissible traction force increase and, alternatively or additionally, a traction force gradient. The permissible increase in traction force can be an absolute value, which is the maximum amount by which the torque in grading operation may increase when the working machine is decelerated to a standstill. The traction force gradient, on the other hand, can be an increase in traction force when the working machine is decelerating. In the embodiment, the method also comprises defining the limited maximum traction force curve based on the ascertained maximum speed and the read-in permissible traction force increase and, alternatively or additionally, traction force gradients. If the traction force gradient is specified, this has the advantage that the driver always gets the same torque increase for the same speed loss, regardless of the gear selected. Within the scope of this embodiment, the shape of the limited maximum traction force curve can therefore be individually set and adjusted by the driver as required.

For example, a traction force support point can be ascertained based on the maximum speed and the conventional maximum traction force curve. In one embodiment, the traction force support point is ascertained based on the conventional maximum traction force curve in such a way that the corresponding maximum traction force value is read from this curve at the ascertained maximum speed. In addition, an increase in the limited maximum traction force curve is determined based on the permissible traction force increase and/or traction force gradient read in. If a traction force gradient is read in, the gradient of the limited maximum traction force curve is independent of the ascertained maximum speed and the traction force reference point. If, on the other hand, a maximum permissible increase in traction force is read in, the gradient of the traction force curve may depend on the ascertained maximum speed and thus on the specified traction force reference point. For example, the gradient may be lower for higher maximum speeds than for lower maximum speeds. Within the scope of this embodiment, a traction force curve can now also be determined based on the traction force support point and the traction force gradient. in this embodiment, the traction force curve can pass through the traction force support point and rise with the specified traction force gradient as the output speed decreases and, accordingly, the travel speed decreases until standstill. The permissible increase in traction force and, alternatively or additionally, the traction force gradient can be specified as an absolute value or as a percentage.

In one embodiment, the method comprises ascertaining a maximum speed of the working machine, which can be done in accordance with the above explanations. In addition, the method comprises selecting a limited maximum traction force curve from a plurality of stored limited maximum traction force curves based on the ascertained maximum speed. Within the scope of this embodiment, different limited maximum traction force curves can be stored for different grading passes and, accordingly, different travel speeds of the working machine during grading. In addition, different limited maximum traction force curves can be stored for different engine speeds in the various grading passes, as described above. The stored limited maximum traction force curves can all be designed in such a way that they increase as the output speed of the drive device decreases and thus as the travel speed decreases. Within the scope of this embodiment, one of the stored limited maximum traction force curves can now be selected based on the ascertained maximum speed. This design has the advantage that, when grading operation is activated, the traction force can be automatically limited to acceptable levels as required without any further action on the part of the driver. This reduces the risk of incorrect operation and thus increases reliability.

In one embodiment, the method comprises ascertaining a currently maximum permissible engine speed based on a limited maximum speed curve of the engine. The limited maximum speed curve decreases as the output speed of the drive device decreases and thus the driving speed decreases. The method of the embodiment comprises comparing a current engine speed with the currently maximum permissible engine speed. If the current engine speed exceeds the currently maximum permissible engine speed, the engine speed is reduced within the scope of this embodiment. If the working machine is in grading operation and the load on the working machine increases, the gearbox of the drive device can be adjusted to lower output speeds as described above. This can cause the working machine to slow down. If this delay in the working machine occurs, the maximum permissible engine speed may decrease within the scope of this embodiment, which may lead to a reduction in the engine speed. This simulated engine braking provides the driver of the working machine with feedback about the increasing load, allowing them to react accordingly, for example by adjusting the grader blade described above. As a result, this embodiment enables improved operation of a grader with a power-split gearbox by means of load feedback via the engine braking.

In one embodiment, the method comprises setting a maximum engine speed for the engine. The maximum engine speed can be ascertained based on the maximum speed of the working machine. Furthermore, within the scope of this embodiment, the method may comprise reading in a permissible engine speed drop and, alternatively or additionally, an engine speed gradient. In addition, the method of this embodiment may include defining the limited maximum speed curve of the engine based on the maximum engine speed and the read-in permissible engine speed drop and/or engine speed gradient. For example, within the scope of this embodiment, an engine speed curve can be determined which starts at the maximum engine speed and then decreases with a constant slope as the output speed of the drive device decreases until the working machine comes to a standstill. The slope at which the engine speed curve drops can depend on the permissible engine speed drop and/or the engine speed gradient that has been read in.

At the same time, this embodiment ensures that a minimum engine speed is maintained. If, for example, the engine speed control results in engine speeds that are below this minimum engine speed, the minimum engine speed can be specified as the maximum permissible engine speed within the scope of this embodiment In this embodiment, the driver of the working machine can therefore adjust the engine reduction as required by specifying a maximum permissible engine speed drop and/or an engine speed gradient. The advantage of specifying the engine gradient is that, regardless of the gear selected, the driver always experiences the same drop in engine speed for the same loss of speed, as long as the engine speed is above the minimum engine speed. The permissible engine speed drop and engine speed gradient can be entered as absolute values or as percentages.

In one embodiment, the method comprises ascertaining an engine speed limitation class, also known as an engine speed limitation class. For different maximum speeds, such as the different virtual gears described above, different limited maximum speed curves for the engine can be stored. Various limited maximum engine speed curves can also be stored for a virtual gear. The different limited maximum speed curves for a virtual gear can deviate from each other at higher driving speeds, i.e., at higher output speeds of the drive device, but can be reduced to the same maximum engine speed at lower output speeds. In an alternative embodiment, the different limited maximum speed curves for a gear are lowered to different maximum speed levels so that they can also differ from one another at very low driving speeds. The limited maximum speed curves can be designed so that they keep the maximum engine speed constant at lower driving speeds, for example at approximately 25% of the ascertained maximum speed.

Based on the ascertained engine speed limitation class, a maximum speed curve can now be selected from the large number of limited maximum speed curves for the engine. If, for example, a higher engine speed limitation class is ascertained, a maximum speed curve can also be selected which allows higher maximum speeds at higher driving speeds. Accordingly, for a low engine speed limitation class, a maximum speed curve can be selected that allows lower maximum engine speeds at higher driving speeds. The engine speed limitation class can be set by a driver of the working machine. Alternatively, or additionally, the engine speed limitation class can also be set automatically based on certain parameters. The present embodiment has the advantage that the limited maximum speed curve can be selected automatically and as required and does not have to be set by a driver of the working machine. This ensures a reliable and robust working machine.

Furthermore, the present invention relates to a control device that is set up, i.e., specifically designed, for example programmed, to carry out a method according to one of the embodiments described above. The control device may have one or more interfaces for communicating with the respective components of the drive device, which may each be designed as input and/or output interfaces. The control device may be a gearbox control device, which may be designed to control the gearbox and, optionally, the engine as well. Furthermore, the present invention relates to a drive device with an engine and a power-split gearbox with a variator for continuously variable adjustment of the transmission ratio of the gearbox. The drive device further comprises a control device for controlling the engine and the power-split gearbox in accordance with the embodiments described above. Furthermore, the present invention relates to a working machine with such a drive device. With regard to the design and advantages of the individual components, reference is made to the above explanations in connection with the method of the present invention.

### BRIEF DESCRIPTION OF THE FIGURES

FIG. 1 schematically shows a working machine according to one embodiment.

FIG. 2 schematically shows a drive device for the working machine from FIG. 1.

FIG. 3 schematically shows a flowchart of a method for operating the drive device from FIG. 2 according to an embodiment.

FIGS. 4a and 4b show the traction force and engine speed curves of the drive device from FIG. 2 in a grading operation according to one embodiment

FIGS. 5a and 5b show the traction force and engine speed curves of the drive device from FIG. 2 in a grading operation according to a further embodiment.

### DETAILED DESCRIPTION OF EMBODIMENTS

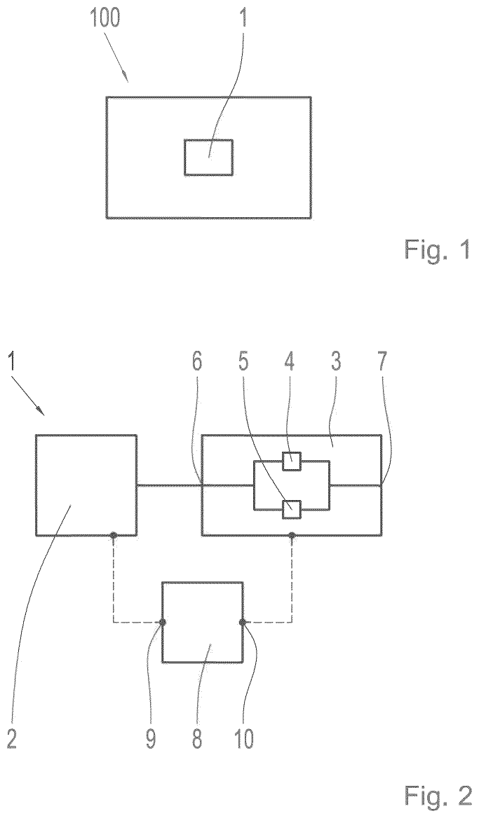

FIG. 1 shows a working machine 100 with a drive device 1 according to an embodiment of the present invention. In the present embodiment, the working machine 100 is a grader. The working machine 100 comprises a plurality of wheels (not shown) which can be driven by the drive device 1. Furthermore, the working machine 100 comprises a grader blade (not shown), which is arranged between a front axle and a rear axle of the grader. FIG. 2 shows a schematic diagram of the drive device 1. The drive device 1 comprises an engine 2, which in the present embodiment is configured as an internal combustion engine. In addition, the drive device 1 comprises a power-split gearbox 3 with a mechanical power path 4 and a hydraulic power path comprising a variator 5. The power-split gearbox 3 has a drive 6 and an output 7. The drive 6 is mechanically connected to engine 2. The output 7 of the power-split gearbox 3 is mechanically connected to the wheels of the working machine 100, which are not shown. The output speed of the drive device 1 at output 7 is in a fixed relationship with the speed of the wheels and thus with the travel speed v of the working machine 100.

Via the mechanical power path 4 of the power-split gearbox 3, which in the present embodiment has several switching elements not shown, different fixed transmission ratios and thus different driving ranges can be switched between the drive 6 and the output 7 of the gearbox 3. Within these driving ranges, the transmission ratio can be continuously adjusted via the variator 5. In the present embodiment, the variator 5 is designed as a hydrostat with two hydraulic machines that are hydraulically connected to each other. By adjusting the displacement of the variator 5, the transmission ratio of the hydraulic power path and thus also the transmission ratio of the gearbox 3 can be continuously adjusted.

In addition, the drive device 1 comprises a control device 8 for controlling the drive device 1, which is designed as a gearbox control device in the present embodiment. The control device 8 comprises an engine interface 9 for controlling the engine 2. Furthermore, the control device 8 comprises a gearbox interface 10 for controlling the power-split gearbox 3, among other things for switching the driving ranges of the mechanical power branch 4 and for adjusting the variator 5 of the hydraulic power branch of the gearbox 3. Various measured variables of the power-split gearbox 3 can also be read out via the gearbox interface 10. For example, the hydrostatic variator 5 has a sensor device that can be used to read a pressure value in the variator 5. In this embodiment, the pressure magnitude is in a fixed relationship with the torque at the output 7 and thus with the traction force Z of the drive device 1.

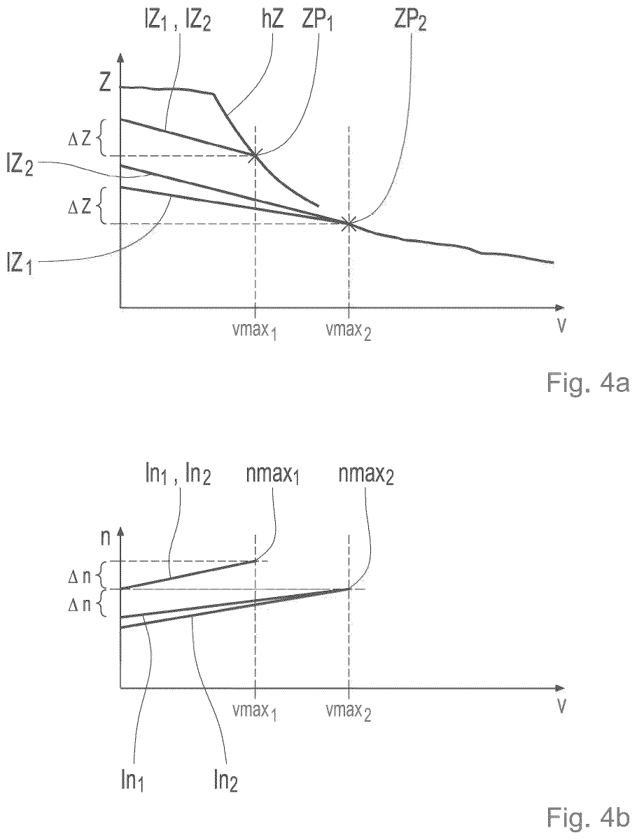

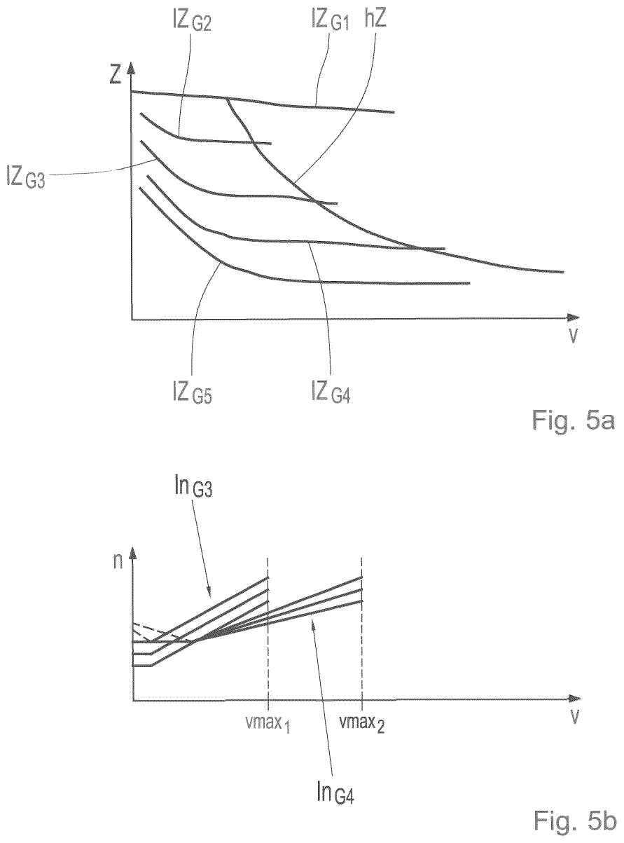

A conventional maximum traction force curve hZ is stored on the control device 8, which assigns different maximum permissible traction forces Z to the drive device 1 depending on the travel speed v of the working machine 100. The conventional maximum traction force curve hZ is shown in FIGS. 4a and 5a. As explained above, the travel speed v is in a fixed relationship with the output speed at output 7. In the present embodiment, the output speed at output 7 is again in a fixed relationship with the reciprocal transmission ratio of the power-split gearbox 3. As shown in FIGS. 4a and 5a, the conventional maximum traction force curve hZ is designed such that the maximum permissible traction force Z decreases with increasing travel speed v. i.e., with increasing output speed at output 7. For lower driving speeds v, the maximum permissible traction force Z remains essentially constant before decreasing exponentially with increasing driving speed v. In the present embodiment, the drive device 1 has different maximum permissible traction force curves hZ for different engine speeds of the engine 2, wherein only one maximum permissible traction force curve hZ is shown in FIGS. 4a and 5a. The various maximum permissible traction force curves hZ differ from one another, but all essentially follow the curve shown in FIGS. 4a and 5a.

If the working machine 100 moves at a certain speed v and a load builds up, the drive device 1 increases the traction force Z and attempts to keep the speed v constant. If, on the other hand, the traction force Z reaches the maximum permissible traction force hZ at the current driving speed v, the control device 8 adjusts the power-split gearbox 3 to smaller reciprocal ratios, thereby slowing down the working machine 100. This process is repeated until the applied load no longer exceeds the maximum permissible traction force hZ at the respective travel speed v and the respective engine speed n.

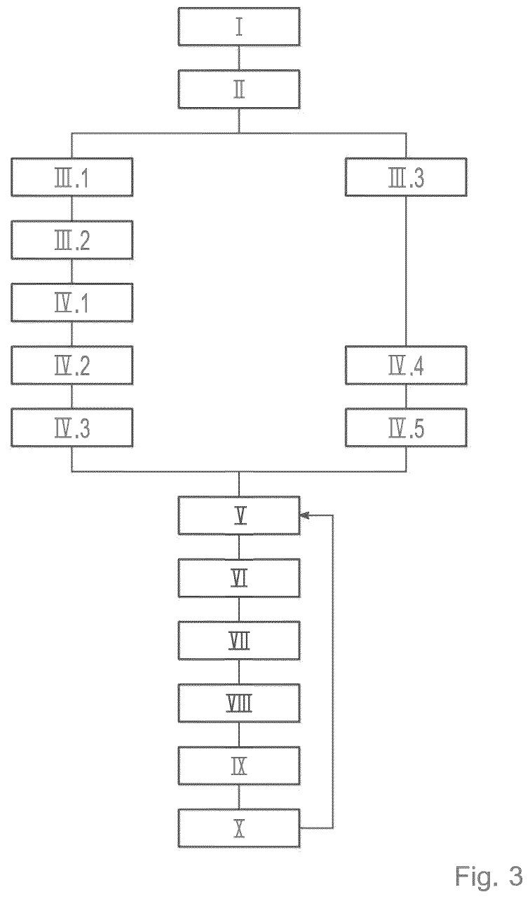

The control device 8 is set up to execute the method described below with reference to FIG. 3. In a first step, the control device 8 ascertains a maximum speed vmax₁ or vmax₂ of the working machine 100. This maximum speed vmax₁ or vmax₂ can be entered by a driver of the working machine 100, for example by specifying a working speed via a virtual gear limit. FIGS. 4a and 4b show two examples of the maximum speeds vmax₁ and vmax₂ that were ascertained. The driver of the working machine can enter these maximum speeds vmax₁ and vmax₂ using a corresponding switch element.

In a subsequent step II, the control device 8 now receives an activation signal to activate a grading operation of the grader 100. In the present embodiment, the activation signal is received by the control device 8 when the virtual gear specified by the driver and thus the maximum speed vmax₁ or vmax₂ of the working machine 100 specified by the driver is less than or equal to a maximum permissible virtual gear for grading operation. To this end, in step II, the control device 8 in the present embodiment compares the virtual gear selected by the driver with a maximum permissible virtual gear for grading operation. If this condition is met and the driver of the working machine 100 has additionally entered a command, for example via a switch, to activate the grading operation of the grader 100, the control device 8 receives an activation signal to activate the grading operation.

In the embodiment shown in FIG. 4a, the control device 8 then reads in a subsequent step III.1 a permissible increase in traction force ΔZ or a traction force gradient, which is entered by the driver of the working machine 100. Subsequently, in a subsequent step III.2, a limited traction force curve IZ is defined based on the maximum speed vmax₁ or vmax₂ ascertained in step I and the permissible traction force increase ΔZ or traction force gradient read in step III.1. As part of step III.2, a traction force reference point ZP₁ or ZP₂ is first ascertained based on the maximum speed vmax₁ or vmax₂ and the conventional maximum traction force curve hZ. More precisely, this traction force reference point ZP₁ or ZP₂ is determined by determining the maximum permissible traction force Z from the conventional maximum traction force curve hZ at the maximum speed vmax₁ or vmax₂. Next, a traction force increase is determined based on the permissible traction force increase ΔZ read in step III.1 or the traction force gradient read in. In the following, a traction force line IZ₁ and IZ₂ is determined through the traction force support point ZP₁ and ZP₂, respectively, with the tensile force gradient.

If the driver of the working machine 100 specified a permissible increase in traction force ΔZ in step III.1, this results in limited maximum traction force lines IZ₁, whose slope depends on the ascertained maximum speed vmax₁ or vmax₂. At a lower maximum speed vmax₁, the traction force curve IZ₁ has a greater slope than at higher maximum speeds vmax₂. If, on the other hand, the driver has entered a traction force gradient, traction force lines IZ₂ with the same gradients result, but these also have different traction force increases over the travel speed range of the working machine 100. All these limited maximum traction force curves IZ₁ and IZ₂ have in common that they pass through the associated traction force reference point ZP and rise less steeply than the conventional maximum traction force curve hZ as the travel speed v decreases, i.e., as the output speed at output 7 decreases.

In an alternative embodiment shown in FIG. 5a, different limited maximum traction force curves IZ_{G} are stored on the control device 8 for different grading passes. In the present embodiment, a limited maximum traction force curve is stored on the control device 8 for a first grading pass IZ_{G1}, for a second grading pass IZ_{G2}, for a third grading pass IZ_{G3}, for a fourth grading pass IZ_{G4}, and for a fifth grading pass IZ_{G5}. All of these limited maximum traction force curves IZ_{G} for the various grading passes, with the exception of the first grading pass IZ_{G1}, which are permanently stored on the control device 8, have a curve in which the maximum permissible traction force Z increases less sharply with decreasing speed v and thus decreasing output speed at the output 7 of the drive device 1 than in the conventional maximum traction force curve hZ. The increase in traction force in the limited maximum traction force curves IZ_{G} towards the lower speed ranges v is initially moderate and then becomes pronounced in order to prevent the vehicle from coming to a standstill in the so-called stall point range. In an alternative embodiment, however, the limited maximum permissible traction force may initially rise moderately toward the lower driving speeds v and then drop moderately.

In both the embodiment shown in FIG. 4a and that shown in FIG. 5a, different limited maximum traction force curves IZ₁, IZ₂, and IZ_{G} for different engine speeds of engine 2 are stored on the control device 8. These different limited maximum traction force curves IZ₁, IZ₂, and IZ_{G} are essentially identical, but differ slightly in their permissible traction forces Z.

In the embodiment shown in FIGS. 4a and 4b, a maximum engine speed nmax₁ and nmax₂ is also ascertained in step IV.1 for the maximum speeds vmax₁ and vmax₂ determined in step I. Furthermore, in step IV.2, a permissible engine speed drop An or an engine speed gradient is read in by the control device 8, which is specified in each case by the driver of the working machine 100. Based on the maximum engine speed nmax1 or nmax₂ specified in step IV.1 and the permissible engine speed drop Δn or engine speed gradient read in step IV.2, a limited maximum speed curve In for engine 2 is defined in step IV.3. In accordance with the explanations in FIG. 4a, this limited maximum speed curve In is defined by drawing a straight line through the maximum permissible engine speed nmax1 or nmax2 and determining its slope based on the permissible engine speed drop Δn or engine speed gradient read in step IV.2. All these permissible maximum speed curves In have in common that they decrease continuously from the maximum speed nmax₁ or nmax₂ with decreasing travel speed v and thus with decreasing output speed at Output 7, as shown in FIG. 4b.

If the driver specifies a permissible engine speed drop Δn, this results in limited maximum speed curves In₁ for engine 2 with different gradients, depending on the maximum speed vmax₁ or vmax₂ determined in step I. With a lower maximum speed vmax₁, the limited maximum speed curve In₁ has a greater slope than with a higher maximum speed vmax₂. If, on the other hand, the engine speed gradient is specified, the limited maximum speed curves In₂ of engine 2 have the same slope but different engine speed drops across the travel speed spectrum of the working machine 100.

In the embodiment shown in FIGS. 5a and 5b, however, different limited maximum speed curves In_{G3} and In_{G4} of engine 2 are stored on the control device 8 for the different grading passes. All these In_{G} curves have in common that they decrease with decreasing travel speed v and thus with decreasing output speed of the output 7, as shown in FIG. 5b. A large number of limited maximum speed curves Ine are stored for each of the grading passes. The various limited maximum speed curves In_{G} can be reduced to the same engine speed n, as shown in the example of In_{G4}, or they can be reduced to different engine speeds n, as shown in the example of In_{G3}. In one embodiment, the limited maximum speed curves of the engine 2 are designed such that when the speed falls below approximately 25% of the maximum driving speed v of the selected gear, they maintain the engine speed n and do not reduce it further. In an alternative embodiment, however, a limited maximum speed curve In_{G} of the engine 2 can also be designed so that it rises to lower driving speeds v, as shown by the dashed lines in FIG. 5b.

In the embodiment shown in FIGS. 5a and 5b, the control device 8 now ascertains, in a subsequent step IV.4, an engine speed limitation class which can be set automatically by the driver or by the control device 8. Subsequently, in a subsequent step IV.5, the control device 8 selects one of the plurality of limited maximum speed curves Inc stored on the control device 8 in the respective grading pass. With a higher engine speed limitation class, a limited maximum speed curve Ino of engine 2 with a higher maximum permissible engine speed n is selected than with a lower engine speed limitation class.

In a subsequent step V, the control device 8 now ascertains the current traction force Z of the drive device 1. For this purpose, the sensor device described above in the variator 5 is used in the present embodiment. Furthermore, in step V, the currently maximum permissible attraction force Z is ascertained based on the limited maximum traction force curve IZ₁, IZ₂, or IZ_{G}. In a subsequent step VI, the current traction force Z is now compared with the currently maximum permissible traction force Z. If the current traction force Z exceeds the maximum permissible traction force Z, which was ascertained based on the limited maximum traction force curve IZ₁, IZ₂, or IZ_{G}, the control device 8 then adjusts the transmission ratio of the power-split gearbox 3 in a step VII. The transmission ratio is adjusted to a lower output speed at output 7 of the drive device 1. For example, in this embodiment, the variator 5 of the power-split gearbox 3 is adjusted for this purpose. This leads to a delay in the working machine 100 and thus to a lower travel speed v.

In step VIII, the control device 8 now ascertains the currently maximum permissible engine speed n based on the previously determined limited maximum speed curve In₁, In₂, or Ino of the engine 2. Furthermore, the control device 8 ascertains the current engine speed n in this step. In a subsequent step IX, the control device 8 compares the current engine speed n with the currently maximum permissible engine speed, which was determined based on the limited maximum speed curve In₁, In₂, or In_{G}. If the current engine speed n exceeds the maximum permissible engine speed, the control device 8 reduces the engine speed n in a subsequent step X via the engine interface 9. The method then returns to step V.

### REFERENCE NUMBERS

100 working machine
1 drive device
2 engine
3 power-split gearbox
4 mechanical power path
5 variator
6 drive
7 output
8 control device
9 engine interface
10 gearbox interface
I ascertaining maximum speed
II receive activation signal
III.1 reading in permissible increase in traction force and/or traction force gradient
III.2 defining limited maximum traction force curve
III.3 selecting the traction force curve from a variety of stored traction force curves
IV.1 set maximum engine speed
IV.2 reading in permissible engine speed drop and/or engine speed gradient
IV.3 defining limited maximum speed curve
IV.4 ascertaining the engine speed limitation class
IV.5 select maximum speed curve from a variety of stored maximum speed curves
V ascertaining the currently maximum permissible traction force
VI compare current traction force with current maximum permissible traction force
VII adjusting the transmission ratio of the gearbox
VIII ascertaining the current maximum permissible engine speed
IX compare current engine speed with current maximum permissible engine speed
X reduce engine speed
Z traction force
VF travel speed
n engine speed
IZ₁, IZ₂, IZ_{G} limited maximum traction force curve
hZ conventional maximum traction force curve
ZP₁, ZP₂ traction force support point
vmax₁, vmax₂ maximum speed
ΔZ permissible reduction in traction force
Δn permissible engine speed drop
nmax₁, nmax₂ maximum permissible engine speed
In₁, In₂, In_{G} limited maximum speed curve

1. A method for operating a drive device (1) for a working machine (100), wherein the drive device (1) has an engine and a power-split gearbox (3) with a variator (5) for continuously variable adjustment of a transmission ratio of the gearbox and wherein the drive device (1) has a conventional maximum traction force curve (hZ) in which the maximum permissible traction force (Z) of the drive device (1) increases with decreasing output speed of the drive device (1), the method comprising:
receiving (II) an activation signal for activating a grading operation of the working machine (100), wherein the grading operation has a limited maximum traction force curve (IZ₁; IZ₂; IZ_{G}) and in which the maximum permissible traction force (Z) of the drive device (1) increases less sharply than in the conventional maximum traction force curve (hZ) as the output speed of the drive device (1) decreases;
ascertaining (V) a currently maximum permissible traction force (Z) based on the limited maximum traction force curve (IZ₁; IZ2; IZ_{G});
comparing (VI) a current traction force (Z) with the currently maximum permissible traction force (Z); and
adjusting (VII) the transmission ratio of the gearbox (3) towards a lower output speed of the drive device (1) based on the comparison.

2. The method according to claim 1, wherein the method comprises:
ascertaining (I) a maximum speed (vmax₁, vmax₂) of the working machine (100);
reading in (III.1) a permissible increase in traction force (ΔZ) and/or a traction force gradient; and
defining (III.2) the limited maximum traction force curve (IZ₁; IZ₂) based on the ascertained maximum speed (vmax1; vmax2) and the read-in permissible traction force increase (ΔZ) and/or traction force gradient.

3. The method according to claim 2, wherein defining (III.2) the limited maximum traction force curve (IZ₁; IZ₂) comprises:
determining a traction force reference point (ZP₁; ZP₂) based on the ascertained maximum speed (vmax₁; vmax₂) and the conventional maximum traction force curve (hZ);
determining a traction force gradient based on the read-in permissible traction force increase (ΔZ) and/or traction force gradients; and
determining a traction force straight line through the traction force reference point (ZP₁; ZP₂) with the traction force gradient.

4. The method according to claim 1, wherein the method comprises:
ascertaining (I) a maximum speed (vmax₁; vmax₂) of the working machine (100); and
selecting (III.3) a limited maximum traction force curve (IZ_{G}) from a plurality of stored limited maximum traction force curves (IZ_{G}) based on the ascertained maximum speed (vmax₁; vmax₂).

5. The method according to claim 1, wherein the method comprises:
ascertaining (VIII) a currently maximum permissible engine speed (n) based on a limited maximum speed curve (In₁; In₂; In_{G}) of the engine (2), which has a decreasing curve with decreasing output speed of the drive device (1);
comparing (IX) a current engine speed (n) with the ascertained current maximum permissible engine speed (n); and
reducing (X) the engine speed (n) based on the comparison.

6. The method according to claim 5, wherein the method comprises:
determining (IV.1) a maximum engine speed (nmax₁; nmax₂) of the engine (2);
reading in (IV.2) a permissible engine speed drop (Δn) and/or an engine speed gradient; and
defining (IV.3) the limited maximum speed curve (In₁; In₂) based on the maximum engine speed (nmax₁; nmax₂) and the read-in permissible engine speed drop (Δn) and/or engine speed gradient.

7. The method according to claim 5, wherein the method comprises:
ascertaining (IV.4) an engine speed limitation class; and selecting (IV.5) a limited maximum speed curve (In_{G}) of the engine (2) from a plurality of stored limited maximum speed curves (In_{G}) based on the ascertained engine speed limitation class.

8. A control device (8) configured to carry out the method according claim 1.

9. A drive device (1) with an engine (2), a power-split gearbox (3) with a variator (5) for continuously variable adjustment of a transmission ratio of the gearbox (3) and a control device (8) for controlling the engine and a control device configured to carry out the method according to claim 1.

10. A working machine (100) comprising:
an engine (2); a power-split gearbox (3) with a variator (5) for continuously variable adjustment of a transmission ratio of the gearbox (3); and
a control device (8) for controlling the engine (2) and control device configured to carry out the method according to claim 1.
